(19) United States
(12) Patent Application Publication
(10) Pub. No.: US 2006/0268298 A1
(43) Pub. Date: Nov. 30, 2006

(54) Color space conversion by storing and reusing color values

(76) Inventors: Sidharth Wali, Gurgaon (IN); Jay Russell Shoen, Boise, ID (US); Sudhanshu Mittal, New Delhi, IN (US)

Correspondence Address: AVAGO TECHNOLOGIES, LTD., P.O. BOX 1920, DENVER, CO, 80201-1920, US

(21) Appl. No.: 11/232,258

(22) Filed: Sep. 20, 2005

(30) Foreign Application Priority Data
May 27, 2005 (IN) 1372/DEL/2005

(51) Int. Cl. H04N 1/60

(52) U.S. Cl. 358/1.9

(57) ABSTRACT

Image data is converted from a first color space to a second color space. An image acquisition device acquires first color space image data of a pixel of an image. It is then determined if the first color space image data of the pixel and second color space image data of the pixel are referenced in a data structure. The second color space image data of the pixel is selected for sending to an output device if the first color space image data and the second color space image data of the pixel are referenced in the data structure. If the first color space image data and the second color space image data of the pixel are not referenced in the data structure, then the first color space image data of the pixel is transformed into the second color space image data of the pixel. The data structure can be a hash table. Also, the first color space can be RGB and the second color space can be CYMK.

### FIELD OF THE INVENTION

The invention relates to the field color space conversion.

### BACKGROUND OF THE INVENTION

In a traditional color printing system, color image data composed of three-dimensional color signals supplied to a personal computer from a color image scanner is displayed on a color monitor and also printed by a color printer.

Traditional color printers are based on 4-color printing, using black (K), in addition to the three primary colors of cyan (C), magenta (M), and yellow (Y). Theoretically black can be produced by mixing the three CMY colors; however, due to the difficulty in achieving pure black due to impurities in the ink, it's common to add black as a fourth color for printing.

Currently six- and seven-color printers are also available, in which light cyan, light magenta, and other colors are added to the CMYK primaries.

An image displayed on a monitor using the three RGB primary colors must be converted to CMYK for printing. Each computer printer comes with printer driver software that converts color images created on the computer into a data format that can be processed by the color printer.

Monitors and scanners that use the three RGB primary colors, and color printers and printed matter that use the CMYK colors, each have a different range of reproducible colors. The full range of colors that can be produced by any color reproduction system is called the color “gamut” of that system. Thus, the monitors, scanners and color printers have different color gamuts.

To make it convenient to handle many different input and output devices, it is becoming more common to describe the colors in a “device-neutral” (also called device-independent) color space. This color space essentially describes how the color is seen by the eye and typically uses color spaces originally standardized by the CIE in their 1931 or later standards. In recent standards by the International Color Consortium, these spaces are also referred to as Profile Connection Spaces (PCS), where the profiles describe how given device color descriptions are transformed into (or from) the PCS. The device-neutral space can be L*a*b*, defined by CIE, where L* is the lightness and a* and b* are color differences from gray (roughly described as red-green and blue-yellow). In general, conversions to/from these spaces require multi-dimensional conversions, usually done in computers by three or four dimensional lookup tables (LUTs).

A picture of all available colors (a color “space”) is often drawn as a colored disk. The colored disk is typically a “plane” of the “CIE color space”. The color gamuts of individual devices are then drawn on the available gamut as polygons. For color monitors, printers and scanners the polygons typically have vertices corresponding to any of the six “primary” colors: cyan, magenta, yellow, red, green, and blue used by the devices. The area inside a polygon represents all the colors that can be achieved with that particular device.

FIG. 1A is a chromaticity diagram 10 of the CIE color space 12 with an RGB monitor color gamut 14 plotted thereon. FIG. 1B is the chromaticity diagram 10 of the CIE color space 12 with a CYMK printer color gamut 16 plotted thereon.

As can be seen from FIGS. 1A and 1B, the color printer gamut represented by 16 is smaller than and does not include all the colors of the monitor color gamut 14. This is because gamut of colors that can be reproduced by a CMYK color printer is smaller than what can be shown on an RGB monitor. Thus, the full range of colors that can be displayed on the color monitor cannot be reproduced by the color printer. As a result, RGB colors that look wonderful on a computer screen sometimes become dull or less saturated when converted to CMY (or CMYK) for a color printout.

Gamut mapping, or color space conversion, is a technique for adjusting the color across different devices so that the image seen by the human viewer will be as consistent as possible when reproduced on devices with different ranges of reproducible color. This technique is used by color management systems (CMS).

There are several different methods for gamut mapping. One simple solution is to move all the points of the color monitor polygon directly inward to the nearest point on that color printer polygon, while matching all other points as accurately as possible. This provides the best possible match to all colors that can be accurately matched, and is great for hitting spot colors, but it tends to produce lousy reproductions of photographs.

Consider a photograph of an apple in which the reds of the highlights have to all be moved, and that by these rules they are all moved to the same point on the color printer polygon. As we view the photograph, we'll see a terrible “fringe” surrounding the highlight as the area of out-of-gamut colors that have been run-together transitions to the area where more accurate color reproduction is possible.

This is often called a “colorimetric” correction which results from a “colorimetric ICC profile”.

A more satisfactory solution is to “deform” the entire surface of the color monitor gamut so that all points are moved into the color printer polygon, while avoiding “clipping” colors so that colors that differed in the original are knocked down to be the same color in the reproduction. Colors that are within both of the gamut polygons will be less accurately reproduced, but the reproductions will be free of the “fringes” described above. This is often called a “perceptual” or “photometric” correction which results from a “perceptual ICC profile”.

When an image is to be output by an image output device, a complicated mathematical transformation must be performed on the image to convert if from device-neutral image data, such as L*a*b*, to device-specific image data, such as cyan (C), magenta (M), yellow (Y) and black (K), for the particular output device. Alternatively, if the original data is specific to the input device, then calibration data is needed and the equivalent of the transformation from input device to device-neutral to output device-specific output is done as one even more complicated mathematical transformation.

It would be desirable to be able to convert the color space representation of each pixel of an image without having to repeatedly perform complicated mathematical transformations on every pixel.

### SUMMARY OF THE INVENTION

Image data is converted from a first color space to a second color space. An image acquisition device acquires first color space image data of a pixel of an image. It is then determined if the first color space image data of the pixel and second color space image data of the pixel are referenced in a data structure. The second color space image data of the pixel is selected for sending to an output device if the first color space image data and the second color space image data of the pixel are referenced in the data structure. If the first color space image data and the second color space image data of the pixel are not referenced in the data structure, then the first color space image data of the pixel is transformed into the second color space image data of the pixel. The data structure can be a hash table. Also, the first color space can be RGB and the second color space can be CYMK.

### BRIEF DESCRIPTION OF THE DRAWINGS

FIG. 1A is a chromaticity diagram of the CIE color space with an RGB monitor color gamut plotted thereon.

FIG. 1B is a chromaticity diagram of the CIE color space with a CYMK printer color gamut plotted thereon.

FIG. 2 illustrates a configuration of a color space conversion system of the present invention.

FIG. 3 is a flow chart the color space conversion method of the present invention which is used by the system FIG. 2.

FIG. 4 is a flow chart giving a more specific hash table example of the method described in the flow chart of FIG. 3.

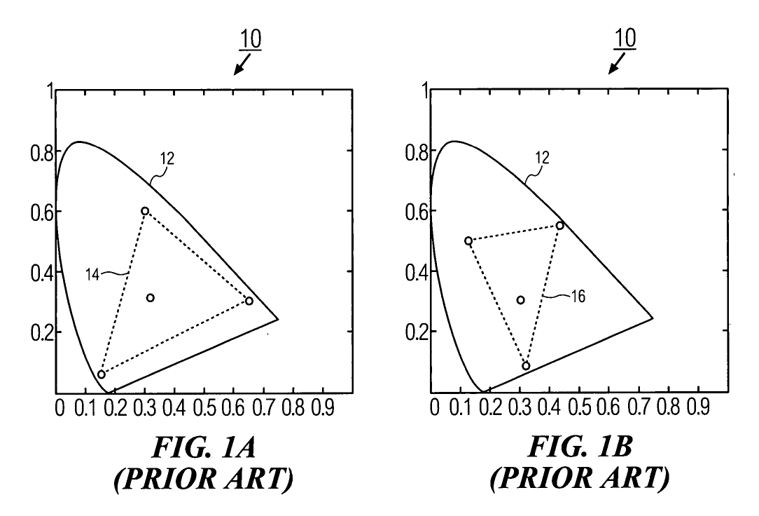

### DETAILED DESCRIPTION

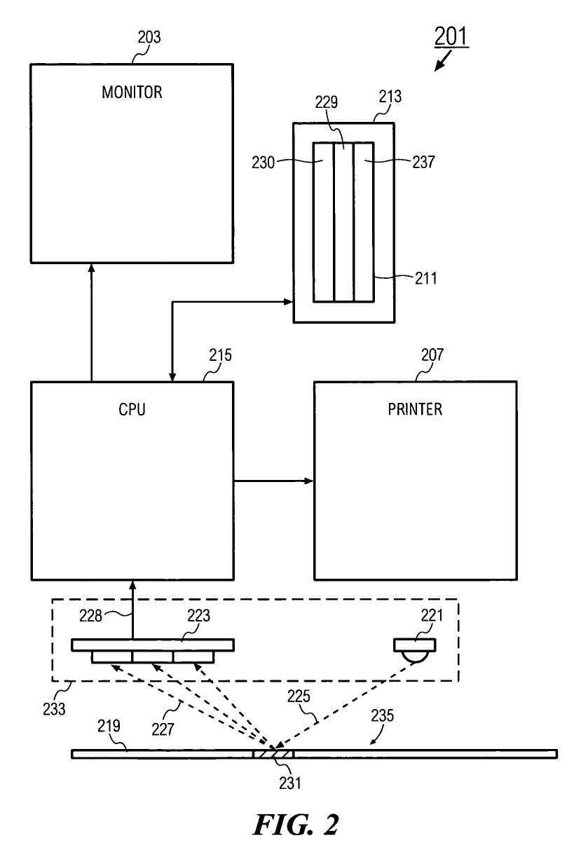

FIG. 2 illustrates a configuration of a color space conversion system 201 of the present invention. The system is illustrated in black and white although the actual system produces and displays colors.

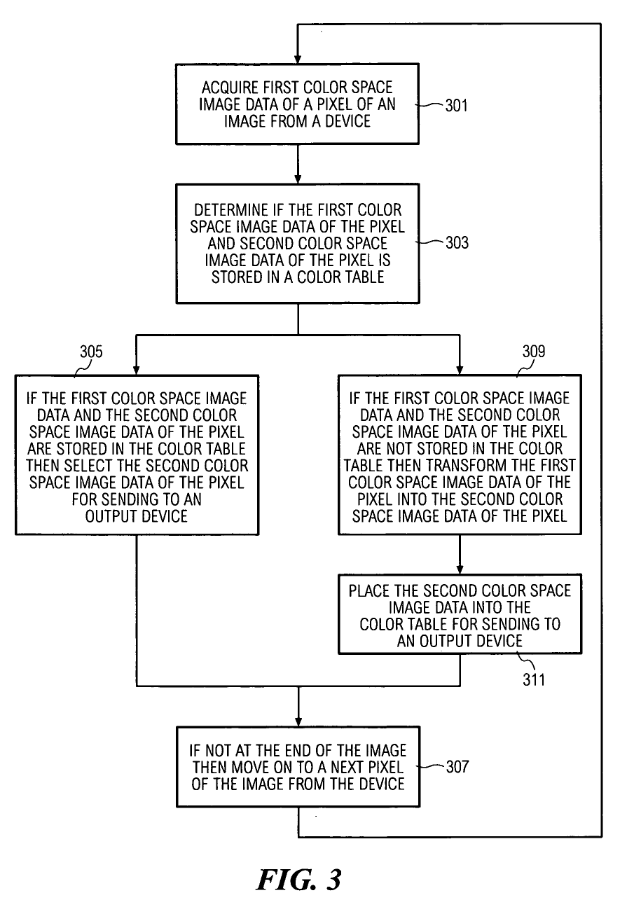

FIG. 3 is used to illustrate the color space conversion method of the present invention which is used by the system illustrated in FIG. 2.

At STEP 301, a processor or CPU 215, which can be part of a personal computer, a hardwired switching apparatus or other processing device, acquires first color space image data 229 of a pixel 231 of an image 235 from a image acquisition device 233. The first color space image data 229 can be stored in a color table 211 stored in a storage section 213.

The device 233 can be a color scanner, color camera, fax machine or photocopier, for example. The image 235 and it's pixel 231 can be formed on a piece of paper 219.

In the color scanner example, the color scanner device 233 includes a light source 221 and a color sensor 223. The light source 221 emits light 225 towards the pixel 231 of the image 235 formed on the paper 219. Light 227 is reflected from the pixel 231 and collected by the color sensor 223. The first color space image data 229 is output by a signal 228 from the color scanner device 223 to the processor 215. The light source/color sensor and paper are moved relative to each other to acquire first color space image data 229 for subsequent pixels.

Alternatively, the image acquisition device 233 can be a storage device storing the first color space image data 229. In one embodiment the storage device stores first color space image data which is created directly on the computer by a computer software such as ADOBE PHOTOSHOP, CORELDRAW, or AUTOCAD. In this embodiment, the image 235 and it's pixel 231 can be in electronic format.

The first color space image data 229 of the pixel 231 acquired by the processor 215 can be in the RGB color space, a device-neutral space or other color spaces.

The first color space image data 229 of the pixel 231 and the other pixels forming the image 235 need to be converted to second color space image data 237 for outputting to an output device. The output device can be the color monitor 203 or a color printer 207, illustrated in FIG. 2, or any other output device.

The color table 211 is stored in the storage section 213. The color table 211 stores the first color space image data 229 for pixels in the image 235 and the second color space image data 237, which is calculated by performing a mathematical transformation on the first color space image data 229. The color table 211 also includes a column 230 for indexing each row.

The second color space image data 237 can be RGB data for outputting by the processor 215 to the monitor 203 using a signal 217 to reproduce the image 235. Alternatively, the second color space image data 237 can be CYMK data for outputting by the processor 215 to the printer 207 using a signal 239 to reproduce the image 235.

At STEP 303 the processor 215 determines if the first color space image data 229 of the pixel 231 and second color space image data 237 of the pixel 231 is stored in the color table 211.

At STEP 305, if it is determined by the processor 215 that the first color space image data 229 and the second color space image data 237 of the pixel 231 are stored in the color table 211 then the second color space image data 237 is sent to the output device.

At STEP 307, if the pixel 231 examined in STEP 305 is the last pixel of the image, then the steps of the method end. However, if there are other pixels to be examined then the method continues on, starting with STEP 301.

After STEP 303, at STEP 309, if it is determined by the processor 215 that the first color space image data 229 and the second color space image data 237 of the pixel 231 are not stored in the color table 211, then a mathematical transformation is performed. There are many well known prior-art transformations that can be used. The second color space image data 237 is calculated by performing this mathematical transform operation on the first color space image data 229.

Next, at STEP 311 the second color space image data 237 is placed into the color table 237 for sending to the output device.

After STEP 311, STEP 307 is performed as described above.

The above method speeds up the preparation of second color space image data for sending to the output device. The method does not require a complicated mathematical transformation of every pixel of the image 235. Rather, if a second color space value has already been calculated for the first color space value of a first pixel, then if a second pixel is found to have the same first color space value the already-calculated second color space value will be used for the second pixel as well. This avoids an extra mathematical transformation of the first color space value of the second pixel. Therefore, time and computing resources are conserved.

In a preferred embodiment the color table is a hash table. Hash tables provide improved search (storage and retrieval) efficiency compared to other data structures. Hash tables are well known in the art, but not the particular implementation of hash tables of the present invention.

A hash table works very well in the present invention because there are relatively few possible colors, while there are usually many pixels in the image. Therefore there will be many pixels sharing the same colors.

A hash table is made up of two parts: an array (the actual table where the data to be searched is stored) and a mapping function, known as a hash function. The hash function is a mapping from the input space to the integer space that defines the indices of the array. In other words, the hash function provides a way for assigning numbers to the input data such that the data can then be stored at the array index corresponding to the assigned number.

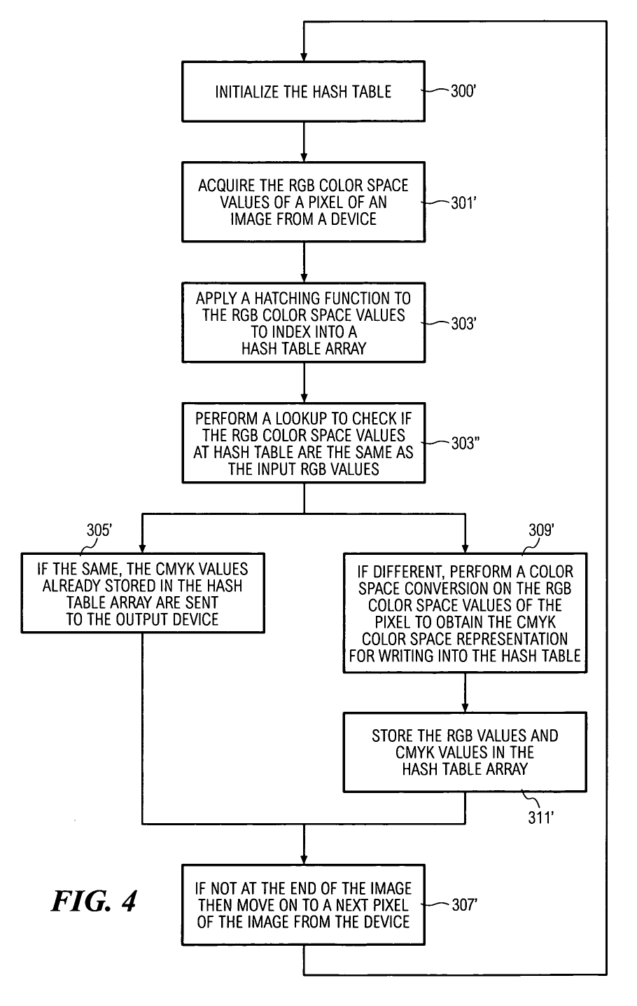

FIG. 4 provides a flow chart giving a more specific example of the method described in the flow chart of FIG. 3. The method described in FIG. 4 uses a hash table as the color table.

TABLE 1 illustrates the hash array used in the present invention. This hash array can replace the color table 211 illustrated in FIG. 2. The size of the hash array is set to 128. The size is set to 128 so that it will not take up much memory and will allow for a fast hash search. The first column (column “0”) contains RGB values and the second column (column “1”) contains CMYK values. Each array row has an index number (0, 1, 2, . . . , 110, . . . 127).

TABLE 1

| Index | RGB | CMYK |
|---|---|---|
| 0 | 0xffffff00 | 0x00000000 |
| 1 | 0xffffff00 | 0x00000000 |
| 2 | 0xffffff00 | 0x00000000 |
| * | 0xffffff00 | 0x00000000 |
| * | 0xffffff00 | 0x00000000 |
| * | 0xffffff00 | 0x00000000 |
| * | 0xffffff00 | 0x00000000 |
| 110 | 0xfbfbfb00 | 0x00000004 |
| * | 0xffffff00 | 0x00000000 |
| * | 0xffffff00 | 0x00000000 |
| 127 | 0xffffff00 | 0x00000000 |

The array is initialized at step 300′ by filling all the of the rows in the RGB column of the table with RGB white values which are (0×ff, 0×ff, 0×ff). This is written as “0×ffffff00”. All the rows in the CYMK column of the table are filled with CYMK white values which are (0×00, 0×00, 0×00, 0×00). This is written as “0×00000000”. Other values can also be used to initialize the array.

Assume that at STEP 301′ (see FIG. 4) the RGB color values of a near to white pixel 231 (see FIG. 2) is acquired by the processor 215. The RGB color space values for this pixel are (0×fb, 0×fb, 0×fb). This is presented as “0×fbfbfb00”.

At STEP 303′ a hashing function is applied to “0×fbfbfb00”, the color space value of the pixel 231, to index into the hash table array. The index value “110” is generated. The hashing function can be selected from one of the many available in the prior art.

At STEP 303″ a lookup is performed to check if the RGB value at hash array position (“110”, “0”) is the same as the input RGB value. In this way it is determined whether or not the color space conversion from RGB to CYMK has already been calculated. The RGB value stored at hash array position (“110”, “0”) is “0×ffffff00”. This is different than the RGB value “0×fbfbfb00” of the pixel 231. Therefore it is determined that the first color space (RGB) image data of the pixel and second color space (CYMK) image data of the pixel is not stored in the color table (hash table array).

At STEP 309′, because the RGB data for the pixel 231 has not been stored in the hash array, it is necessary to perform a color space conversion on the RGB value “0×fbfbfb00” of the pixel 231 to obtain the CYMK color space representation for writing into the hash table position at the second column of row “110”, i.e. (“110”, “1”). The transformation results in the CYMK values (0×00, 0×00, 0×00, 0×04). This is represented as “0×00000004”.

If the acquired pixels have more colors than the hash array positions, in this case 128, then “collisions” are likely to occur. This happens when two inputs will hash to the same output. This indicates that both elements should be inserted at the same place in the array, and this is impossible. For example, if a first pixel having a first color hashes to the position “101”, and later a second pixel having a second color, different from that of the first color, also hashes to the position “101” then a collision occurs. There are many algorithms for dealing with collisions, such as linear probing and separate chaining. However, in the present embodiment, if a collision occurs the subsequent pixel RGB and CYMK color space representations are allowed to overwrite those of the earlier pixel. This is not a problem since there is a huge amount of pixel replication (lot of pixels with same color), and therefore the same color will still be repeated many times, allowing the present invention to provide increased efficiency.

At STEP 311 ′ the RGB value “0×fbfbfb00” and CYMK value “0×00000004” are stored in the hash table array at row “110”. More specifically, the RGB value is stored at the first column of row “110”, i.e. (“110”, “0”) of the hash table array. The CYMK value is stored at the second column of row “110”, i.e. (“110”, “1”) the hash table array (see TABLE 1).

At STEP 307′ if the pixel 231 examined in STEP 311′ is the last pixel of the image, then the steps of the method end. However, if there are other pixels to be examined then the method continues on, starting with STEP 301′.

When RGB color space for a subsequent pixel are acquired and after performing STEPS 301′, 303′ and 303″ it is determined that the same RGB values and therefore the transformed CYMK values have already been stored in the hash table, then STEP 305′ is performed, rather than STEP 309′, whereby the CYMK values already stored in the hash table array are sent to the output device.

Following STEP 309′, STEP 307′ is performed again as described above.

The present invention skips color space conversion for any pixel whose color has appeared earlier. It grabs the color space converted value from a color table rather than computing a fresh value for each pixel. This provides an increase of speed by 5 to 6 times over prior art approaches where color space converted values are computed for every pixel of an image.

It should be noted that in the previous description, when it is said that data is stored in the color table/hash table array, this is meant to include data not only stored in the color table/hash table array but referenced by linked lists stored in the color table/hash table array. Similarly, data “referenced” in the color table/hash table array can be data actually stored in the color table/hash table array or data referenced by linked lists stored in the color table/hash table array. Also, the invention is not limited to using color tables/hash tables, but rather other appropriate data structures can be used instead for efficient arranging and searching for the data.

In the foregoing specification, the invention has been described with reference to specific exemplary embodiments thereof. The specification and drawings are, accordingly, to be regarded in an illustrative sense rather than a restrictive sense.

1. An apparatus for converting image data from a first color space to a second color space comprising:
an image acquisition device acquiring first color space image data of a pixel of an image;
a data structure for referencing the first color space image data of the pixel and second color space image data of the pixel;
a processor for determining if the first color space image data of the pixel and second color space image data of the pixel are referenced in the data structure, and when they are not both referenced in the data structure transforming the first color space image data of the pixel into the second color space image data of the pixel and referencing the second color space image data of the pixel in the data structure; and
an output device for receiving the second color space image data of the pixel when the first color space image data and the second color space image data of the pixel are referenced in the data structure.

2. The apparatus of claim 1, wherein the data structure is a hash table.

3. The apparatus of claim 1, wherein:
the data structure is a hash table comprising a hash table array and a hash function and the hash table array is initialized with color values;
the first color space image data and the second color space image data of the pixel are referenced in the data structure if they are stored in the hash table array;
the first color space image data and the second color space image data of the pixel are not referenced in the data structure if they are not stored in the hash table array;
and wherein:
the processor determines if the first color space image data of the pixel and second color space image data of the pixel are referenced in the data structure by applying the hashing function to the first color space image data of the pixel to generate an index value and using the index value to search the array for the second color space image data of the pixel; and
the processor transforms the first color space image data of the pixel into the second color space image data of the pixel and stores it at the hash table array position corresponding to the index value if the second color space image data of the pixel is not referenced in the data structure.

4. The apparatus of claim 1, wherein the first color space is RGB and the second color space is CYMK.

5. The apparatus of claim 1, wherein the first color space is a device-independent color space and the second color space is CYMK.

6. The apparatus of claim 1, wherein the image acquisition device is selected from the group consisting of: color scanner, color camera, fax machine and photocopier.

7. The apparatus of claim 1, wherein the image acquisition device is a storage device storing the first color space image data.

8. A method for converting image data from a first color space to a second color space comprising the steps of:
acquiring first color space image data of a pixel of an image from an image acquisition device;
determining if the first color space image data of the pixel and second color space image data of the pixel are referenced in a data structure;
selecting the second color space image data of the pixel for sending to an output device if the first color space image data and the second color space image data of the pixel are referenced in the data structure;
transforming the first color space image data of the pixel into the second color space image data of the pixel if the first color space image data and the second color space image data of the pixel are not referenced in the data structure.

9. The method of claim 8, wherein the data structure is a hash table.

10. The method of claim 8, wherein:
the data structure is a hash table comprising a hash table array and a hash function and the hash table array is initialized with color values;
the first color space image data and the second color space image data of the pixel are referenced in the data structure if they are stored in the hash table array;
the first color space image data and the second color space image data of the pixel are not referenced in the data structure if they are not stored in the hash table array;
and wherein:
the step of determining if the first color space image data of the pixel and second color space image data of the pixel are referenced in the data structure further comprises the steps of applying the hashing function to the first color space image data of the pixel to generate an index value and using the index value to search the array for the second color space image data of the pixel and outputting the second color space image data to the output device; and
the step of transforming the first color space image data of the pixel into the second color space image data of the pixel if the second color space image data of the pixel is not referenced in the data structure is followed by the step of storing the second color space image data of the pixel at the hash table array position corresponding to the index value.

11. The method of claim 8, wherein the first color space is RGB and the second color space is CYMK.

12. The method of claim 8, wherein the first color space is a device-independent color space and the second color space is CYMK.

13. The method of claim 8, wherein the image acquisition device is selected from the group consisting of: color scanner, color camera, fax machine and photocopier.

14. The method of claim 8, wherein the image acquisition device is a storage device storing the first color space image data.
